(19) United States
(12) Patent Application Publication
(10) Pub. No.: US 2015/0298537 A1
(43) Pub. Date: Oct. 22, 2015

(54) WHEEL MOTOR CONFIGURATION FOR VEHICLE MOTORIZATION

(71) Applicant: BIONX CANADA INC., Sherbrooke (CA)

(72) Inventors: Jean-Martin DUHAMEL, Sherbrooke (CA); Pascal LAROSE, Sherbrooke (CA)

(73) Assignee: BIONX CANDA INC., Sherbrooke (CA)

(21) Appl. No.: 14/353,413

(22) PCT Filed: May 15, 2012
(86) PCT No.: PCT/CA2012/050812

§ 371 Date: Apr. 22, 2014

Related U.S. Application Data
(60) Provisional application No. 61/559,785, filed on Nov. 15, 2011.

(51) Int. Cl. B60K 7/00; H02K 11/00; H02K 1/18; H02K 1/16; H02K 5/20; H02K 5/10

(52) U.S. Cl. CPC B60K 7/0007; H02K 5/20; H02K 5/10; H02K 1/187; H02K 1/16; H02K 11/0073; B60K 2007/0092

(57) ABSTRACT

A wheel motor comprises a stator portion comprising a core secured to an axle and defining air-circulation openings extending through the core, a stator ring mounted about a periphery of the core. The stator ring has teeth separated by slots and windings on the teeth, the windings are connected to a wheel motor controller. A rotor portion comprises an annular case, and structural members rotatably connecting the annular case to the axle, the annular case enclosing permanent magnets opposite the teeth of the stator portion. The structural members define an air-circulation openings extending through the rotor portion. A shielding configuration is between the annular case and an annular surface of the stator portion radially spaced from the axle to define a shielded chamber enclosing the stator ring. The sealed chamber is radially outward of air channels concurrently defined by the air-circulation openings in the stator portion and the rotor portion.

### CROSS-REFERENCE TO RELATED APPLICATION

The present application claims priority on U.S. Provisional Patent Application No. 61/559,785, incorporated herewith by reference.

### FIELD OF THE APPLICATION

The present application relates to wheel motors—also known as wheel hub motor, in-wheel motor, hub motor, wheel hub drive—for vehicle motorization.

### BACKGROUND OF THE ART

gam Wheel motors are commonly used for the motorization of vehicles, such as bicycles, scooters, lightweight motorcycles, cars, etc. A wheel motor comprises a stator hub with windings, and a rotor wheel rotating about the hub. The rotor wheel comprises a plurality of magnets driven by the current in the windings. Advantageously, the wheel motor operates as a direct drive; there is no transmission to convert the motor output to a given speed. The power output of the wheel motor is as a function of the electrical current fed to the wheel motor.

There are continuous efforts to increase the power output from wheel motors. Some parameters can be used to alter the power output of the wheel motors, such as magnet size and current increase. However, an increase in torque is known to generate additional heat, which must be dissipated to avoid damaging components of the wheel motor. Therefore, the torque output of wheel motors may be constrained by heat generation.

### SUMMARY OF THE APPLICATION

It is therefore an aim of the present disclosure to provide a wheel motor configuration that addresses issues associated with the prior art.

Therefore, in accordance with the present application, there is provided a wheel motor comprising: stator portion comprising a core secured to an axle and defining air-circulation openings extending through the core, a stator ring mounted about a periphery of the core, the stator ring having teeth separated by slots and windings on the teeth, the windings adapted to be connected to a wheel motor controller; a rotor portion comprising an annular case, and at least one structural member rotatably connecting the annular case to the axle, the annular case enclosing permanent magnets opposite the teeth of the stator portion, the at least one structural member defining air-circulation openings extending through the rotor portion; and a shielding configuration between the annular case and an annular surface of the stator portion radially spaced from the axle to define a shielded chamber enclosing the stator ring, the sealed chamber being radially outward of air channels concurrently defined by the air-circulation openings in the stator portion and the rotor portion.

Further in accordance with the present disclosure, the core has arms, with the stator ring being connected to ends of the arms, the air-circulation openings being between the arms.

Still further in accordance with the present disclosure, the arms are substantially radial in the wheel motor.

Still further in accordance with the present disclosure, at least one of the arms has an inner channel extending from the core to the stator rings for wires to pass therethrough to reach the windings.

Still further in accordance with the present disclosure, the core defines an inner cavity, and further comprising a printed circuit board of the wheel motor controller in the inner cavity and a cover sealingly connected to the core to encapsulate the printed circuit board in the inner cavity.

Still further in accordance with the present disclosure, an access to the inner cavity is axial relative to the wheel motor.

Still further in accordance with the present disclosure, the inner cavity communicates with the inner channel of the at least one of the arms for the printed circuit board to be connected to the windings therethrough.

Still further in accordance with the present disclosure, the axle has a channel for receiving wires, and wherein the channel in the axle communicates with the inner cavity.

Still further in accordance with the present disclosure, the printed circuit board is annular.

Still further in accordance with the present disclosure, a spline coupler is between the shaft and the core.

Still further in accordance with the present disclosure, the shielding configuration comprises annular seals between the annular case and the stator portion such that the shielded chamber is a hermetically sealed chamber.

Still further in accordance with the present disclosure, the annular seals are positioned against a radially inward annular surface of the stator ring.

Still further in accordance with the present disclosure, the annular seals are positioned against axially inward flanges of the annular case.

Still further in accordance with the present disclosure, the annular seals are U-cup seals.

Still further in accordance with the present disclosure, the at least one structural member is a plurality of arms extending from the axle to the annular case.

Still further in accordance with the present disclosure, there is provided a vehicle comprising at least a pair of wheels, with at least one of the wheels incorporating the wheel motor as described above.

Still further in accordance with the present disclosure, a brake disk is secured to the at least one structural member of the rotor portion, and a brake caliper secured to a frame of the vehicle.

Still further in accordance with the present disclosure, the wheel motor has 48 teeth.

Still further in accordance with the present disclosure, the wheel motor has 44 permanent magnets.

Still further in accordance with the present disclosure, the permanent magnets have a width ranging between 42.0 to 52.0 mm.

Still further in accordance with the present disclosure, the rotor portion has an interior diameter ranging between 310.0 mm and 370.0 mm.

Still further in accordance with the present disclosure, the wheel incorporates the wheel motor comprises an outer diameter ranging between 500 mm and 700 mm.

### BRIEF DESCRIPTION OF THE DRAWINGS

FIG. 1 is a first-side perspective view of a wheel motor in accordance with an embodiment of the present disclosure;

FIG. 2 is second-side perspective view of the wheel motor of FIG. 1, showing components of a brake system;

FIG. 3 is an exploded view of the wheel motor of FIG. 1;

FIG. 4 is a side elevation view of the wheel motor of FIG. 1;

FIG. 5 is a sectional view of the wheel motor of FIG. 4, taken along sectional lines V-V;

FIG. 6 is a sectional view of the wheel motor of FIG. 4, taken along sectional lines VI-VI; and

FIG. 7 is a sectional view of a rotor portion of the wheel motor of FIG. 1.

### DESCRIPTION OF THE PREFERRED EMBODIMENTS

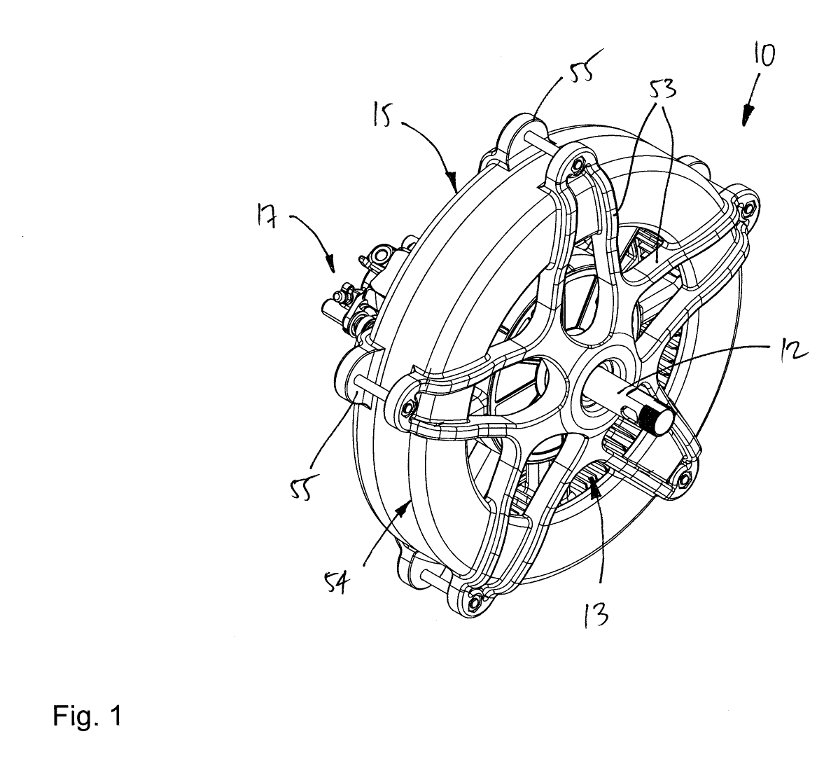

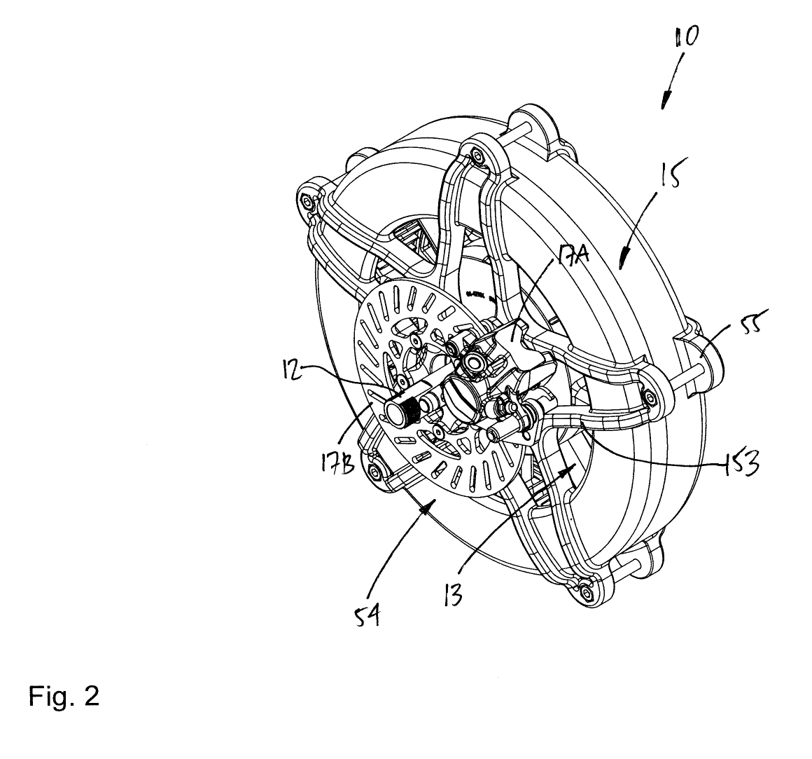

Referring to the drawings and more particularly to FIGS. 1 and 2, there is illustrated a wheel motor at 10 in accordance with an embodiment of the present disclosure. The wheel motor 10 is also known as a wheel hub motor, in-wheel motor, hub motor, wheel hub drive. The wheel motor 10 may be used for electric motorization, for vehicles such as scooters, motorcycles, bicycles, cars, carts, among numerous other possibilities.

The wheel motor 10 comprises an axle 12, by which the wheel motor 10 is mounted to the vehicle. For instance, the axle 12 may be connected to a frame of the vehicle, to a steering component, suspension component, etc. Moreover, as set forth hereinafter, the axle 12 may house wires relating the wheel motor 10 to a user interface and to a battery pack or like source of electric power.

A stator portion is generally shown at 13 in FIG. 1. In the present disclosure, the stator portion 13 is generally defined as the part of the wheel motor 10 between the axle 12 and a rotor portion 15, and therefore forms a structural component of the wheel motor 10. The stator portion 13 supports windings and electronic components that drive the rotor portion 15. Moreover, in accordance with the present disclosure, the stator portion 13 is designed to act as a heat dissipater.

In the present disclosure, the rotor portion 15 generally defined as the part of the wheel motor 10 that is mounted about the stator portion 13 and is rotatingly supported by the axle 12. The rotor portion 15 has an annular shape in accordance with the present disclosure. Although not shown, a remainder of the wheel is radially connected to the rotor portion 15. For instance, spokes or a rim project radially from the rotor portion 15, with a tire being connected to the rim.

Referring to FIG. 2, the wheel motor 10 may support a brake system 17, with a brake caliper 17A integral with the structure of the vehicle, and a disk 17B, rotating with the rotor portion 15.

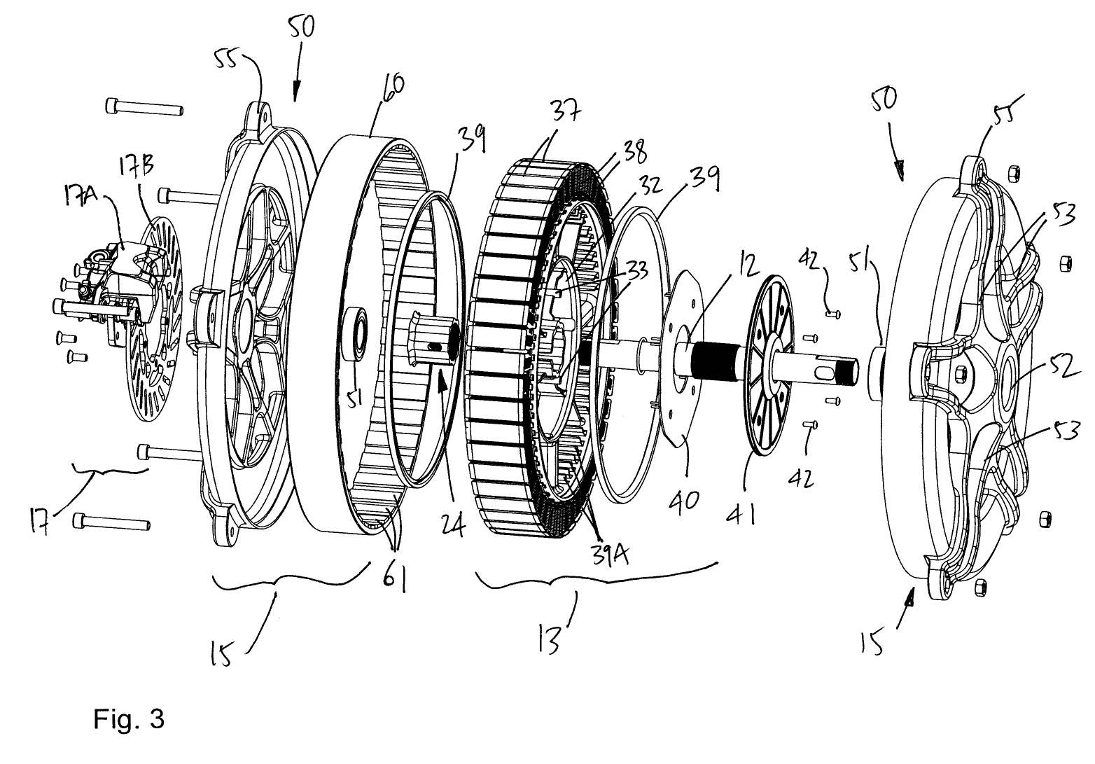

Referring concurrently to FIGS. 3, 5 and 6, the axle 12 is shown having an elongated hollow body. The axle 12 must be made of appropriate materials (e.g., steel, titanium, aluminum, etc), as it is a structural component of the wheel motor 10, interfacing the wheel motor 10 to the vehicle. The elongated hollow body defines an inner cavity 20, with an outer opening 21 and an inner opening 22, both communicating with the inner cavity 20. Ends of the axle 12 are shown as being open as a result of machining. The ends may be plugged, or may also be used instead of the outer opening 21 to thread wires. The inner opening 22 communicates with a housing within the stator portion 13, in which are accommodated electronic components. Therefore, wires pass through the inner cavity 20 of the axle 12, and via the outer opening 21 (or ends of the axle 12) and the inner opening 22 to interrelate the electronic components and windings of the stator portion 13 to other electronic components on the vehicle. The outer opening 21 or ends of the axle 12 may be aligned with suspension arms of the vehicle (or other component, such as fork, chain stay, supports, etc), for the wires to communicate from the axle 12 directly to an interior of the suspension arms.

Shoulders 23 are defined on the outer surface of the axle 12. The shoulders 23 may be used to define abutments for rotor bearings, to ensure the proper alignment of the rotor portion 15 relative to the stator portion 13. Moreover, other shoulders may be formed in the outer surface of the axle 12, for the connection of the axle 12 to the vehicle, etc. Referring to FIG. 3, a spline coupler 24 may be positioned on a central portion of the axle 12 to interface the axle 12 to the stator portion 13. The axle 12 may be machined, cast, etc to be coupled to the spline coupler 24 (e.g., splined, flat surfaces, etc). Although the coupler 24 is a spline, alternative configuration are considered as well, including interfacing the stator portion 13 directly to the axle 12.

Referring concurrently to FIGS. 3, 5 and 6, the stator portion 13 has a core 30 (i.e., stator ring support). The core 30 is integrally secured to the axle 12, whereby the axle 12 and the core 30 are fixed relative to one another. The core 30 is for example made of a metallic, plastic or composite material, and may be machined, cast, molded, forged, stamped to define some cavities, channels, etc. Appropriate material used for the core 30 include aluminum, magnesium, generic thermoplastic or many other material combining a low density and good heat conduction properties.

The core 30 may feature housing 31, to accommodate control electronics of the wheel motor 10 in an inner cavity 32 of the housing 31. Posts 33 are integrally formed as part of the housing 31, and will be used to secure a cover to the housing 31 to hermetically seal the lateral open face of the inner cavity 32 (i.e., axially opened).

Radial arms 34A and 34B project radially from the core 30. The arms 34 (i.e., arms 34A and 34B) may or may not be in radial alignment with a center of the core 30, although shown as being in such radial alignment. The arms 34 are preferably integrally cast with the core 30. Hence, as shown in the figures, openings (i.e., channels) extend from one axial side of the core 30 to the other axial side of the core 30, allowing air circulation therethrough. The arms 34A may be provided with channels 35. The channels 35 communicate with the inner cavity 32, and are used to pass wires that will power windings of the stator portion 13. The number of channels 35 is as a function of the phase arrangements of the wheel motor 10. It is pointed out that plugs may be used to prevent water infiltration through the axle 12 or through the channels 35 and into the inner cavity 32. The arms 34B may be present for structural and heat dissipating purposes.

A stator ring 36 (in some instances known as a yoke) is peripherally mounted to the radial arms 34. The stator ring 36 has teeth 37 circumferential distributed thereon. The teeth 37 are separated from one another by slots, with each of the teeth 37 supporting windings 38. The number of teeth 37 and the orientation of the windings is dependent on the phase arrangement of the wheel motor 10. In the illustrated embodiment, the wheel motor 10 is a three-phase synchronous machine with forty-eight teeth 37. The stator ring 36 is preferably made of laminations in soft magnetic steel.

Annular seals 39 may be positioned on a radially-inward portion of the stator ring 36, or on a radially-outward rim that is integral with the arms 34. Fins 39A may be disposed on this radially-inward surface. In yet another embodiment, the annular seals 39 may contact an annular surface of the stator ring 36 in an axial plane (i.e., the surface lying in a plane to which the axis of the axle 12 is normal). The annular seals 39 are on opposite sides of the wheel motor 10, and will hermetically seal the gap between the stator portion 13 and a casing of the rotor portion 15, as described hereinafter. The seals 39 may have a cup section (as shown), but other sections are considered as well (e.g., wiper seal, o-ring, double lip, etc). Any appropriate material may be used for the seals, such as nitrile, etc.

Referring concurrently to FIGS. 3, 5 and 6, a printed circuit board 40 (PCB) is sized to be received in the inner cavity 32 of the housing 31. The PCB 40 supports various electronic components for the operation of the wheel motor 10. A cover 41 (e.g., same material choice as core 30) is sealingly mounted to the posts 33 by fasteners 42, to hermetically seal the inner cavity 32. The inner and outer peripheral edges of the cover 41 may be provided with channels to accommodate seals such as o-rings that will perform the sealing. It is observed that the cover 41 is in a fixed relation relative to the core 30, whereby seals need not be selected as a function of rotational friction. Some components of the PCB 40 may be in direct contact with the cover 41 and core 30. For instance, mosfets may heat up, whereby the mosfets of the PCB may use the cover 41 and/or core 30 as a heat sink. Appropriate thermal pads may be used where appropriate to maximize heat conduction while preventing electrical conduction.

Although not shown, other electrical components may be present on the stator portion 13. For instance, sensors (e.g., Hall-effect sensors) may be used to detect the position of the rotor portion 15 relative to the stator portion 13 to operate the three phases motor arrangement.

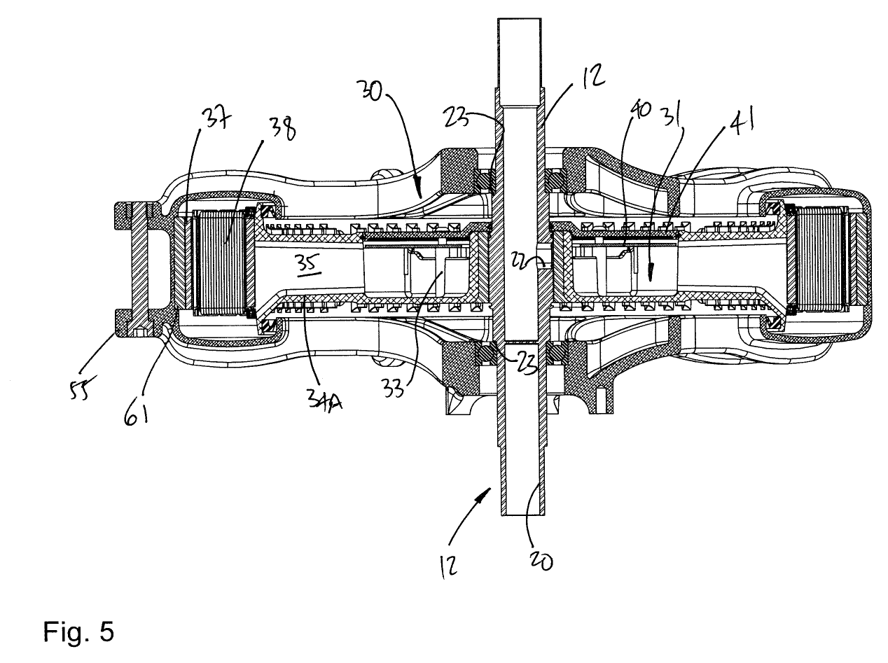

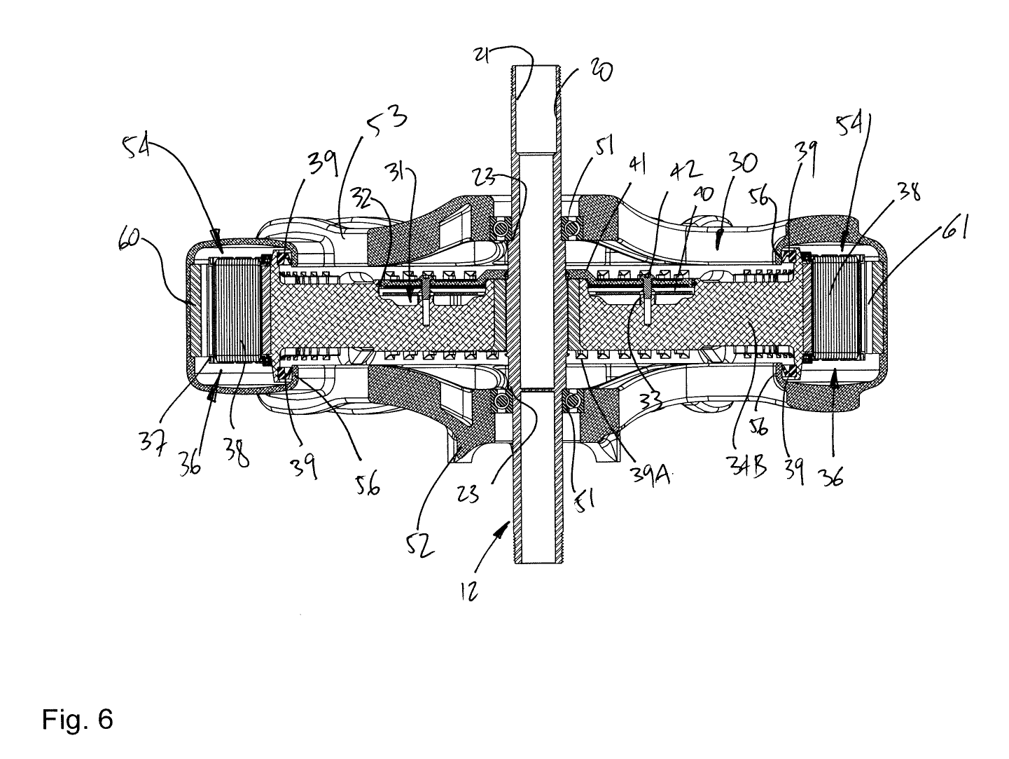

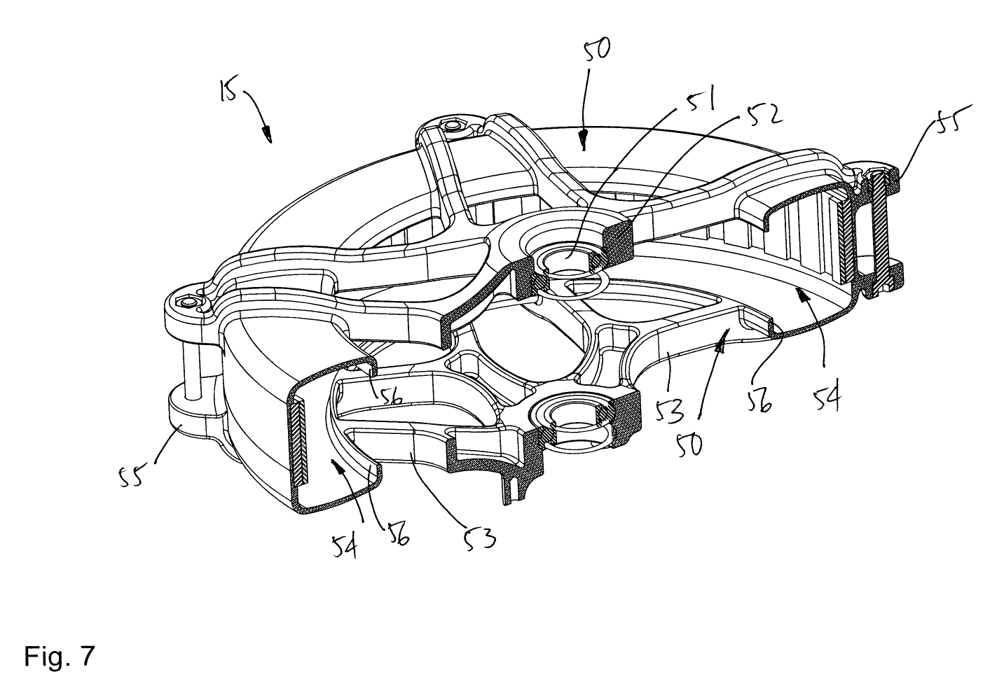

Referring concurrently to FIGS. 3, 5, 6 and 7, the rotor portion 15 is shown having a pair of casing portions 50. The casing portions 50 define an outer body of the rotor portion 15, and are thus connected to other components of the wheel, as explained hereinafter. The casing portions 50 are preferably cast, stamped or forged, and appropriate materials include aluminum, magnesium and steel. The casing portions 50 are connected to the axle 12 by bearings 51 (FIGS. 5 and 6), whereby the rotor portion 15 rotates about the axle 12 and the stator portion 13. The bearings 51 may abut against the shoulders 23 of the axle 12. According to an embodiment, the bearings 51 are oversized compared to bearings conventionally used in bicycle wheels. Any appropriate bearing size is considered. The casing portions 50 each have a hub 52 for housing the bearings 51. Spokes 53 (a.k.a., arms) project radially from the hubs 52 and support an annular case 54, formed by the combination of the casing portions 50. The hubs 52, the spokes 53 and the annular case portions are preferably integrally cast or formed together. The wheel motor 10 is shown as having five of the spokes 53, although more or less of these spokes 53 could be used. Any other suitable structural member(s) is contemplated as an alternative to the spokes 53. For instance, a disc could be used between the axle 12 and the annular case 54. However, in such an embodiment, the disc may be provided with openings therein to allow air circulation from one axial side to the other axial side of the rotor portion 15.

An interior of the annular case 54 forms with the stator ring 36 the magnetic chamber of the wheel motor 10. Therefore, the annular case 54 is sized to accommodate a substantial portion of the stator ring 36, including the teeth 37 and windings 38, and all other electronic components and wires. Sets of flanges 55 on the outer periphery to interconnect the casing portions 50. The annular case 54 has a C-shape, with a pair of inward lips 56 on opposite sides. Any other appropriate section is considered, such as trapezoidal, or with angled or rounded corners, etc. The lips 56 will contact the annular seals 39, to seal off the inside of the annular case 54, and hence define a sealed magnetic chamber. Other shielding arrangements or configurations are possible as well. In yet another embodiment, there is a small gap between the stator ring 36 and the annular case 54, forming a baffle-like barrier to prevent dust infiltration in the magnetic chamber. In such an embodiment, no seals are employed, whereby the magnetic chamber is partially hermetically sealed. Hence, the magnetic chamber is shielded from water, dust, etc, and in some instances may be hermetically isolated therefrom.

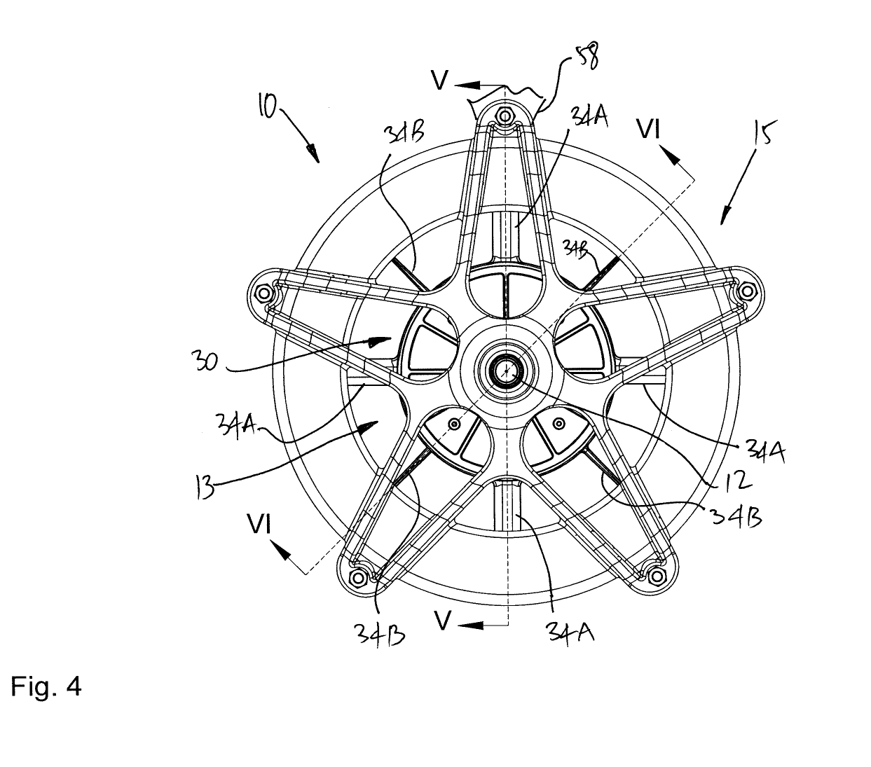

Referring to FIG. 6, there is illustrated a gap between the flanges 55 of the adjacent casing portions 50. The gap between flanges 55 may be used for direct mounting to a rim, with the flanges 55 permitting a double shear assembly. The gap provides enough space for a complementary flange 58 of a rolled or cast rim (i.e., part of a vehicle), as shown in FIG. 4. Other mounting configurations are considered as well.

Referring concurrently to FIGS. 3, 5, 6 and 7, a ring 60 is located within the annular case 54 and is secured thereto, whereby the ring 60 rotates with the casing portions 50. An inner surface of the ring 60 supports permanent magnets 61. The number of magnets is selected as a function of the number of teeth 27. In the illustrated embodiment, there are forty-four magnets 61 in the ring 60, although a different number is contemplated (e.g., forty-four magnets 61). The ring 60 is sized such that a clearance gap is defined between the magnets 61 and the teeth 37 of the of the stator portion 13, optimized to create electromagnetic forces between the stator portion 13 and the rotor portion 15.

Accordingly, the magnetic chamber is confined to a periphery of the stator portion 13, by the shielding configuration between the annular case 54 and the stator ring (or periphery of the core 30), i.e., by the use of the seals or a baffle-like configuration. A substantial portion of the core 30 of the stator portion 13 is therefore exposed to an environment of the wheel motor 10, including the radial arms 34 and the housing 31. The wheel motor 10 therefore comprises numerous heat sinks (i.e., fins) to dissipate the heat generated in the magnetic chamber, the core 30 and the casing portions 50. Moreover, the wheel motor 10, by its configuration, has transversally-disposed channels concurrently defined by the openings in the rotor portion 15 and in the core 30, thereby allowing air circulation through the wheel motor 10. In the illustrated embodiment, the channels define daylight passages through the wheel motor 10, in a direction parallel to an axis of rotation of the wheel motor 10. In operation, the wheel motor 10 is exposed to wind and air convection, helping in the cooling of the wheel motor 10.

According to an embodiment, the wheel motor 10 is used to power a vehicle such as a scooter capable of top speeds ranging between 60 km/h and 90 km/h, depending on surrounding conditions (e.g., wind, weight, slope, tire pressure and width, etc). Such an embodiment may be achieved in specific conditions with the wheel motor 10. For instance, the embodiment with:
Forty-eight teeth 37 and forty-four magnets 61;
An interior diameter ranging between 310.0 mm and 370.0 mm for the rotor portion 15;
Magnets 61 having a width ranging from 42.0 to 52.0 mm; may operate in such top speed ranges for a motor speed of 0-1000 rpm, for a wheel having an outer diameter ranging between 500 mm and 700 mm. Other embodiments are considered as well, depending on the contemplated use of the wheel motor 10.

1. A wheel motor comprising:
a stator portion comprising a core secured to an axle and defining air-circulation openings extending through the core, a stator ring mounted about a periphery of the core, the stator ring having teeth separated by slots and windings on the teeth, the windings adapted to be connected to a wheel motor controller;
a rotor portion comprising an annular case, and at least one structural member rotatably connecting the annular case to the axle, the annular case enclosing permanent magnets opposite the teeth of the stator portion, the at least one structural member defining air-circulation openings extending through the rotor portion; and
a shielding configuration between the annular case and an annular surface of the stator portion radially spaced from the axle to define a shielded chamber enclosing the stator ring, the sealed chamber being radially outward of air channels concurrently defined by the air-circulation openings in the stator portion and the rotor portion.

2. The wheel motor according to claim 1, wherein the core has arms, with the stator ring being connected to ends of the arms, the air-circulation openings being between the arms.

3. The wheel motor according to claim 2, wherein the arms are substantially radial in the wheel motor.

4. The wheel motor according to claim 2, wherein at least one of the arms has an inner channel extending from the core to the stator rings for wires to pass therethrough to reach the windings.

5. The wheel motor according to claim 1, wherein the core defines an inner cavity, and further comprising a printed circuit board of the wheel motor controller in the inner cavity and a cover sealingly connected to the core to encapsulate the printed circuit board in the inner cavity.

6. The wheel motor according to claim 5, wherein an access to the inner cavity is axial relative to the wheel motor.

7. The wheel motor according to claim 6, wherein the inner cavity communicates with the inner channel of the at least one of the arms for a printed circuit board in the inner cavity to be connected to the windings therethrough.

8. The wheel motor according to claim 5, wherein the axle has a channel for receiving wires, and wherein the channel in the axle communicates with the inner cavity.

9. The wheel motor according to claim 5, wherein the printed circuit board is annular.

10. The wheel motor according to claim 1, further comprising a spline coupler between the shaft and the core.

11. The wheel motor according to claim 1, wherein the shielding configuration comprises annular seals between the annular case and the stator portion such that the shielded chamber is a hermetically sealed chamber.

12. The wheel motor according to claim 11, wherein the annular seals are positioned against a radially inward annular surface of the stator ring.

13. The wheel motor according to claim 11, wherein the annular seals are positioned against axially inward flanges of the annular case.

14. The wheel motor according to claim 11, wherein the annular seals are U-cup seals.

15. The wheel motor according to claim 1, wherein the at least one structural member is a plurality of arms extending from the axle to the annular case.

16. A vehicle comprising:
at least a pair of wheels, with at least one of the wheels incorporating the wheel motor according to claim 1.

17. (canceled)

18. The vehicle according to claim 16, wherein the wheel motor has 48 teeth.

19. (canceled)

20. The vehicle according to claim 19, wherein the permanent magnets have a width ranging between 42.0 to 52.0 mm.

21. The vehicle according to claim 16, wherein the rotor portion has an interior diameter ranging between 310.0 mm and 370.0 mm.

22. The vehicle according to claim 16, wherein the wheel incorporating the wheel motor comprises an outer diameter ranging between 500 mm and 700 mm.
